(19) United States
(12) Patent Application Publication
(10) Pub. No.: US 2024/0418138 A1
(43) Pub. Date: Dec. 19, 2024

(54) GAS METERING VALVE

(71) Applicant: Robert Bosch GmbH, Stuttgart (DE)

(72) Inventors: Daniel Bosse, Markgroeningen (DE); Fabian Fischer, Waiblingen (DE); Marco Beier, Rudolstadt (DE); Oezguer Tuerker, Gerlingen (DE); Torsten Burock, Vaihingen An Der Enz (DE)

(21) Appl. No.: 18/699,948

(22) PCT Filed: Jul. 25, 2022
(86) PCT No.: PCT/EP2022/070779

§ 371 Date: May 24, 2024

(30) Foreign Application Priority Data
Oct. 11, 2021 (DE) 10 2021 211 437.7

(51) Int. Cl. F02M 63/00; F02M 21/02; F16K 41/10

(52) U.S. Cl. CPC F02M 63/0035; F02M 63/0017; F16K 41/10; F02M 21/0269

(57) ABSTRACT

A gas metering valve. The gas metering valve includes a housing, in which a gas chamber is formed, which can be filled with gaseous fuel via an inlet opening and from which gaseous fuel can be discharged in a metered manner via an outlet opening. A valve element is longitudinally moveably arranged in the gas chamber, and has a valve seal surface which cooperates with a valve seat for opening and closing the outlet opening. A magnet armature is connected to the valve element. A bellows is connected in a gas-tight manner to the valve element at one end and to the housing at the other end. The gas-tight connection with the housing is formed along a sealing line. The diameter of the sealing line is greater than the diameter of the valve seat.

### FIELD

The present invention relates to a gas metering valve as used, for example, to meter gaseous fuel into a combustion chamber of an internal combustion engine or an intake tract of an internal combustion engine.

### BACKGROUND INFORMATION

Gas metering valves with which gaseous fuel can be metered into the combustion chamber or an intake tract of an internal combustion engine are described in the related art. For this purpose, gaseous fuel is supplied to the gas metering valve at an outlet pressure and fed through a gas chamber formed in the gas metering valve to an outlet opening. A valve element is arranged in the gas metering valve and can be moved by an electric actuator, for example a magnet actuator or piezo actuator, and thereby opens and closes the outlet opening. By energizing the electric actuator, the gaseous fuel can be released through the outlet opening at the right time.

Outwardly opening valves are a design of such gas metering valves, in which the valve element is piston-shaped and an end portion thereof protrudes from the housing. At the combustion chamber end or outlet end, the valve element forms a valve disk with a seal surface facing the gas metering valve, by means of which seal surface the valve element cooperates with a sealing seat for opening and closing the outlet opening. If the valve element is pushed out of the valve seat by the electric actuator and therefore out of the housing, the outlet opening is released and gaseous fuel can flow out past the valve disk. In order to keep the valve closed even when the actuator is de-energized, a closing spring is provided which is arranged in the gas metering valve under a pressure bias and applies a longitudinal force to the valve element with a closing force in the direction of the sealing seat.

In particular, when the gas metering valve meters the gaseous fuel directly into a combustion chamber of an internal combustion engine, the pressure in the combustion chamber acts on the valve element and therefore exerts a closing force on the valve element, which presses it against the sealing seat. If the gas metering valve is to open, the electric actuator must not only overcome the force of the closing spring, but also the pressure force in the combustion chamber, so the actuator must be accordingly dimensioned to be powerful. On the other hand, the gas pressure of the gaseous fuel inside the gas metering valve acts on the valve element, which causes a longitudinal force to act on the valve element in the opening direction. Since the pressure of the gaseous fuel is adjusted depending on the operating state, this longitudinal force varies, and different resulting forces act on the valve element with the same energization. The dynamics of the gas metering valve accordingly vary, which makes precise metering of the fuel difficult. In addition, the opening force due to the pressure in the gas chamber reduces the closing force on the valve element, which must be compensated for by a strong closing spring to ensure tightness. The electric actuator must therefore also overcome this spring force in order to bring the valve element into the open position within the specified time period under all operating conditions.

German Patent No. DE 102 04 655 A1 describes a gas metering valve having a valve element that opens outwards. The valve element is opened by a piezo actuator, wherein a gap is formed between the piezo actuator or the piston connected to it and the actual valve element in order to ensure thermal compensation at different temperatures. The gas pressure in the gas chamber of the gas metering valve exerts an opening force on the valve element, which opening force is overpressed by a closing spring to keep the gas metering valve closed when the actuator is de-energized.

### SUMMARY

The gas metering valve according to the present invention has the advantage that the gas pressure within the gas chamber generates a closing force on the valve element into the gas metering valve and therefore in the closing direction. This additional pneumatic contact pressure on the valve element thereby causes a secure seal, especially at high gas pressures, without the need for a large closing spring which acts on the valve element in the closing direction. This ensures safe and reliable operation of the gas metering valve. For this purpose, the gas metering valve has a housing in which the gas chamber is formed, which can be filled with gaseous fuel via an inlet opening and from which gaseous fuel can be dispensed in a metered manner via an outlet opening. A valve element is longitudinally moveably arranged in the gas chamber, wherein the valve element has a valve seal surface which cooperates with a valve seat for opening and closing the outlet opening. A magnet armature is connected to the valve element and can be moved by an electromagnet. A bellows is connected in a gas-tight manner to the valve element at one end and to the housing at the other end, wherein the gas-tight connection with the housing is formed along a sealing line. The diameter of the sealing line is larger than the diameter of the valve seat, such that, using the pressure in the gas chamber, a resulting pneumatic longitudinal force is exerted on the valve element in the closing direction.

If the pressure in the gas chamber exerts an opening force or no force at all on the valve element, a strong closing spring must be provided that closes the valve element tightly when the electric actuator is switched off. This force must be high enough to ensure this even during pressure peaks. Since the gas metering valve is usually operated with relatively low gas pressures, the magnet actuator must always overcome this high force of the closing spring, which requires a correspondingly large actuator and makes precise control of the gas metering valve more difficult.

As a result of the pneumatic closing force, which is determined by the diameter ratios, a secure seal of the gas metering valve can be achieved, since a stronger closing force also acts as the gas pressure increases. The closing spring can be made correspondingly smaller or possibly omitted altogether, and the electric actuator only needs to apply a small amount of force to open the gas metering valve. Precise metering of the gaseous fuel is thus possible, especially at low gas pressures.

In a first advantageous embodiment of the present invention, the diameter of the sealing line is at least 5% larger than the diameter of the valve seat. This provides sufficient pneumatic closing force so that the described functionality of the gas metering valve is achieved.

In a further advantageous embodiment of the present invention, a valve disk is formed at the outlet end of the valve element, on which disk the valve seal surface is formed which faces the housing. The valve seal surface is advantageously conical in shape and is centered by its shape, which ensures a secure seal.

In a further advantageous embodiment of the present invention, the magnet armature is designed as a plunger armature on which the electromagnet exerts an opening force when energized, wherein compensation does not have to be provided for thermal expansions. This means that the magnet armature can be firmly connected to the valve element and form a unit.

In a further advantageous embodiment of the present invention, the magnet armature is sealed in a gas-tight manner against the gas chamber by the bellows. By separating the magnet armature from the gas chamber, the gaseous fuel does not affect the magnet armature and the other components located there, which contributes to reliable operation of the gas metering valve, especially given aggressive gases. Hydrogen, for example, encourages stress crack corrosion, and therefore in particular components that are subject to high mechanical loads and are sensitive should be protected from hydrogen. In addition, the magnet armature or the region with which the magnet armature is guided in the housing can be wet with a lubricating oil that cannot enter the gas chamber due to the bellows seal.

In a further advantageous embodiment of the present invention, a closing spring is arranged in the gas chamber, which spring is arranged under a pressure bias between a shoulder on the housing and the valve element and exerts a closing force on the valve element in the longitudinal direction. The main function of this closing spring is to keep the gas metering valve closed even when the magnet actuator is switched off.

In a further advantageous embodiment of the present invention, the magnet armature is arranged in a magnet armature chamber which can be filled with gas and in which a lower pressure prevails during operation of the gas metering valve than in the gas chamber, so that a closing force is exerted on the valve element. To ensure this, the magnet armature chamber can advantageously be connected to the ambient air via a compensating line, whereby the ambient pressure of approximately 1 bar (100 kPa) always prevails therein.

### BRIEF DESCRIPTION OF THE DRAWING

FIG. 1 shows a longitudinal cross section through a gas metering valve according to the present invention, wherein only main features are shown.

### DETAILED DESCRIPTION OF EXAMPLE EMBODIMENTS

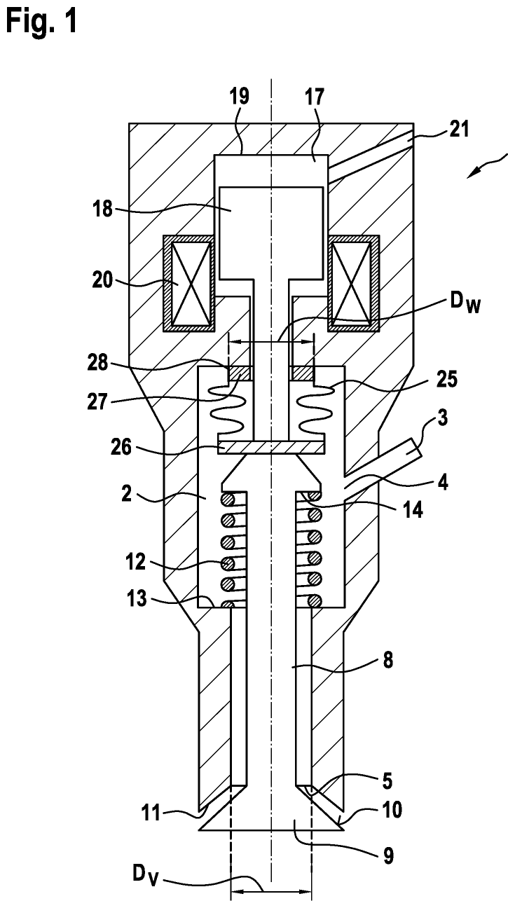

FIG. 1 shows a gas metering valve according to the present invention in longitudinal cross section. The gas metering valve has a housing 1 in which a gas chamber 2 is formed. The lower end region of the housing 1 in FIG. 1 has a cylindrical shape and opens into a circular outlet opening 5. The gas chamber 2 can be filled with a gaseous fuel via a connection 3 formed in the housing 1, which fuel flows into the gas chamber 2 via an inlet opening 4. A piston-shaped valve element 8 is longitudinally moveably arranged in the gas chamber 2 for opening and closing the outlet opening 5 and therefore for metered discharge of the gaseous fuel. At its outlet end, the valve element 8 has a valve disk 9 which has a conical valve seal surface 10. The valve seal surface 10 faces the housing 1 and cooperates with a valve seat 11 formed at the outlet end of the housing 1 for opening and closing the outlet opening 5 so that when the valve seal surface 10 is in contact with the valve seat 11, the outlet opening 5 is closed in a gas-tight manner. At the opposite end of the valve element 8 remote from the outlet opening 5, said element merges into a piston rod 108 which is connected to a magnet armature 18 so that the magnet armature 18 always moves synchronously together with the piston rod 108 and the valve element 8. The magnet armature 18 is designed as a plunger armature and is longitudinally moveably arranged in a magnet armature chamber 17. To move the magnet armature 18 and therefore the valve element 8, an electromagnet 20 is arranged in the housing 1 in the region of the magnet armature chamber 17.

In order to keep the gas metering valve closed when the electromagnet 20 is switched off, a closing spring 12 is arranged in the gas chamber 2, which spring is arranged between a shoulder 13 in the housing 1 and a ring shoulder 14 on the valve element 8 under a pressure bias, and presses the valve element 8 with the valve disk 9 against the valve seat 11. The piston rod 108 which forms part of the valve element 8 is surrounded by a bellows 25. The bellows 25 is connected in a gas-tight manner to a disk 26 which is firmly connected to the valve element 8, and a sealing ring 27 which rests against the housing 1 or is connected to the housing 1. As a result, the bellows 25 seals the gas chamber 2 against the magnet armature chamber 17. The magnet armature chamber 17 is filled with air under ambient pressure, wherein a compensating line 21 formed in the housing 1 establishes a connection with the environment for pressure compensation. Alternatively, it is also possible to fill the magnet armature chamber 17 with an inert gas; in this case, the compensating line 21 is closed after filling.

When the valve seal surface 10 is in contact with the valve seat 11, the gas chamber 2 is sealed along a circular sealing line that has a diameter D_{V}. This means that a pneumatic force acts on parts of the valve disk 9 due to the pressure in the gas chamber 2, which is directed in the opening direction of the valve element 8, i.e. out of the housing 1. On the opposite side of the valve element 8, a pneumatic force acts on the disk 26 in the opposite direction, i.e. in the closing direction of the valve element 8, wherein the seal on the sealing ring 27 is along a circular sealing line 28 with a diameter D_{W}. The gas-tight sealing of the bellows 25 on the sealing ring 27 yields a resulting closing force on the valve element 8 if the diameter D_{W} is greater than the sealing diameter D_{V} on the valve seat. The resulting pneumatically effective surface is then the difference between the surfaces that are bounded by the sealing line 28 and the sealing line on the valve seat 11. Since both surfaces are circular, this results in a differential area of A_{Diff}=π/4·(D_{W}²−D_{V}²), so that the resulting pneumatic force F on the valve element 8 in the closing direction is given by F=A·Δp if Δp is the differential pressure between the gas chamber 2 and the magnet armature chamber 17, and ambient pressure acts on the lower side of the valve disk 9 like it also prevails in the magnet armature chamber 17. In an advantageous way, the diameter D_{W} is at least 5% larger than the diameter D_{V}, so that a pneumatic closing force on the valve element 8 results which is sufficient to always keep the valve element 8 sealed, even with higher pressures in the gas chamber 2.

Since the pressure in the gas chamber 2 generates a closing force on the valve element 8, the force of the closing spring 12 does not need to be high in order to always keep the gas metering valve sealed, even when the electromagnet 20 is switched off. Given a corresponding design of the bellows 25, the closing spring 12 can also be dispensed with since the low closing force still required can be achieved via the tension-biased bellows 25.

1-9. (canceled)

10. A gas metering valve, comprising:
a housing in which a gas chamber is formed, which can be filled with gaseous fuel via an inlet opening and from which gaseous fuel can be discharged in a metered manner via an outlet opening;
a valve element which is longitudinally moveably arranged in the gas chamber, wherein the valve element has a valve seal surface which cooperates with a valve seat for opening and closing the outlet opening;
a magnetic armature which is connected to the valve element and can be moved by an electromagnet;
a bellows which is connected in a gas-tight manner to the valve element at one end and to the housing at the other end, wherein the gas-tight connection with the housing is formed along a sealing line;
wherein a diameter of the sealing line is greater than a diameter of the valve seat, such that, using pressure in the gas chamber, a resulting pneumatic longitudinal force is exerted on the valve element in a closing direction.

11. The gas metering valve according to claim 10, wherein the diameter of the sealing line is at least 5% larger than the diameter of the valve seat.

12. The gas metering valve according to claim 10, wherein a valve disk is formed at an outlet end of the valve element, the valve seal surface being formed on the valve disk and facing the housing.

13. The gas metering valve according to claim 12, wherein the valve seal surface is conical in shape.

14. The gas metering valve according to claim 10, wherein the magnet armature is a plunger armature.

15. The gas metering valve according to claim 14, wherein the magnet armature is sealed in a gas-tight manner against the gas chamber by the bellows.

16. The gas metering valve according to claim 10, wherein a closing spring is arranged in the gas chamber, the closing spring being arranged under a pressure bias between a shoulder on the housing and the valve element and exerts a closing force in a longitudinal direction on the valve element.

17. The gas metering valve according to claim 10, wherein the magnet armature is arranged in a magnet armature chamber which can be filled with gas and in which a lower pressure prevails during operation of the gas metering valve than in the gas chamber.

18. The gas metering valve according to claim 17, wherein the magnet armature chamber is connected to ambient air via a compensating line.
